(19) United States
(12) Patent Application Publication
(10) Pub. No.: US 2022/0198534 A1
(43) Pub. Date: Jun. 23, 2022

(54) ARTIFICIAL INTELLIGENCE SYSTEM FOR TEMPORARY ART EXHIBITS

(71) Applicant: Budget Collector Inc, Kearneysville, WV (US)

(72) Inventors: Ebonique Janine Boyd, Cedar Falls, IA (US); Anya Adelia Ellis, Kearneysville, WV (US)

(21) Appl. No.: 17/557,141

(22) Filed: Dec. 21, 2021

Related U.S. Application Data
(60) Provisional application No. 63/128,438, filed on Dec. 21, 2020.

(51) Int. Cl. G06Q 30/02; H04L 67/55

(52) U.S. Cl. CPC G06Q 30/0282; H04L 67/26; G06Q 30/0206; G06Q 30/0203

(57) ABSTRACT

The disclosure is directed to a computing device that predicts user art preferences. The computing device outputs, for display on a display component, a first piece of art. The computing device receives an indication of user input indicating a user rating for one or more characteristics of the first piece of art by a particular user account. The computing device develops a model based on the user rating for each of the one or more characteristics of the first piece of art. The computing device predicts, using the model, an interest level for the particular user in a second piece of art. The computing device, responsive to the interest level for the particular user in the second piece of art satisfying an interest threshold, sends an invitation to the particular user to view the second piece of art.

### PRIORITY INFORMATION

This application claims priority to U.S. Provisional Patent Application No. 63/128,438, filed Dec. 21, 2020, the entire contents of which are incorporated herein.

### TECHNICAL FIELD

The disclosure relates to an artificial intelligence system for marketing pieces of art.

### BACKGROUND

For years, an issue for art professionals is finding new art collectors. However, the traditional method of finding advice for new collectors is through art advisors who tend to only work with rich clientele. Attending art galleries without any advisor or seeking information on the web is a common method for the average consumer to seek out advice on fine art. In addition, traditional art galleries have based their selection based on the owner's personal taste rather than the selection of the typical consumer.

Traditional art galleries tend to have poor customer service, they often hide their best fine art pieces for their preferred customers. Traditional art galleries tend to hide their prices, where this practice encourages bartering and discrimination. Traditional art galleries do not tend to use market research and data to provide the best selection for users.

### SUMMARY

In general, the techniques of this disclosure is directed to an artificial intelligence (AI) system for marketing physical pieces of art and inviting users who are likely to purchase those limited pieces to an exhibit that will display those pieces of art. For instance, the AI system may monitor how an individual user rates various styles, colors, subjects, and media for physical pieces of art. The AI platform may also consider whether the user owns any physical pieces of art, what physical pieces of art the user owns, a location of the user, and what amount of money the user is capable of spending on physical pieces of art. When a gallery or dealer comes into possession of a new physical piece of art, the AI system may analyze the piece of art, using one or more of automatic image analysis or through input provided by the gallery or dealer, in order to derive various details about the new piece of art at the gallery or dealer. Using those details, the AI system can match the new piece of art with those who are most likely to be interested in renting or purchasing the art based on the user's previously indicated ratings and the numerous other details known to the system. In this way, art galleries and dealerships, that typically only allow for a small amount of customers inside at any given time, may most efficiently market particular articles of manufacture (i.e., physical pieces of art) to those who are most likely to be interested in those physical pieces of art.

In one example, the disclosure is directed to a method in which a computing device outputs, for display on a display component, a first piece of art. The method further includes receiving, by the computing device, an indication of user input indicating a user rating for one or more characteristics of the first piece of art by a particular user account. The method also includes developing, by the computing device, a model based on the user rating for each of the one or more characteristics of the first piece of art. The method further includes predicting, by the computing device, and using the model, an interest level for the particular user in a second piece of art. The method also includes, responsive to the interest level for the particular user in the second piece of art satisfying an interest threshold, sending, by the computing device, an invitation to the particular user to view the second piece of art.

In another example, the disclosure is directed to a device that includes one or more storage components configured to store a model. The device further includes one or more processors configured to output, for display on a display component, a graphical representation of a first piece of art. The one or more processors are further configured to receive an indication of user input indicating a user rating for one or more characteristics of the first piece of art by a particular user account. The one or more processors are also configured to develop the model based on the user rating for each of the one or more characteristics of the first piece of art. The one or more processors are further configured to predict and using the model, an interest level for the particular user in a second piece of art. The one or more processors are also configured to, responsive to the interest level for the particular user in the second piece of art satisfying an interest threshold, send an invitation to the particular user to view the second piece of art.

In another example, the disclosure is directed to a non-transitory computer-readable storage medium having stored thereon instructions that, when executed, cause one or more processors of a computing device to output, for display on a display component, a graphical representation of a first piece of art. The instructions further cause the one or more processors to receive an indication of user input indicating a user rating for one or more characteristics of the first piece of art by a particular user account. The instructions also cause the one or more processors to develop a model based on the user rating for each of the one or more characteristics of the first piece of art. The instructions further cause the one or more processors to predict and using the model, an interest level for the particular user in a second piece of art. The instructions also cause the one or more processors to responsive to the interest level for the particular user in the second piece of art satisfying an interest threshold, send an invitation to the particular user to view the second piece of art.

In another example, the disclosure is directed to a system comprising a user device and a server device configured to perform any of the techniques described herein.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

The following drawings are illustrative of particular examples of the present invention and therefore do not limit the scope of the invention. The drawings are not necessarily to scale, though embodiments can include the scale illustrated, and are intended for use in conjunction with the explanations in the following detailed description wherein like reference characters denote like elements. Examples of the present invention will hereinafter be described in conjunction with the appended drawings.

FIG. 1 is a conceptual diagram illustrating an example user interface, issued by a computing device, for training a model used for predicting interest levels in art, in accordance with one or more of the techniques described herein.

FIG. 2 is a block diagram illustrating a more detailed example of a computing device configured to perform the techniques described herein.

FIG. 3 is a conceptual diagram illustrating an example user interface, issued by a computing device, showing a user's rating preference for a particular piece of art, in accordance with one or more of the techniques described herein.

FIG. 4 is a conceptual diagram illustrating an example user interface, issued by a computing device, showing a user's rating preference for art in general, in accordance with one or more of the techniques described herein.

FIG. 5 is a flow diagram illustrating an example interest prediction technique, in accordance with one or more of the techniques described herein.

### DETAILED DESCRIPTION

The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

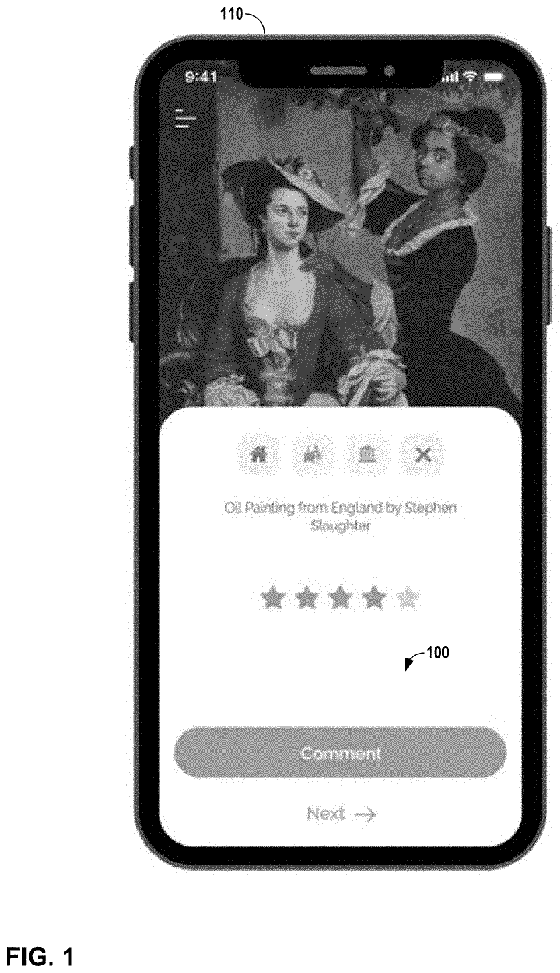

FIG. 1 is a conceptual diagram illustrating an example graphical user interface (GUI) 100, issued by a computing device (e.g., computing device 210), for training a model used for predicting interest levels in art, in accordance with one or more of the techniques described herein. Computing device 210 may be a server which communicates with user device 110 to output GUI 100.

GUI 100 presents, minimally, a graphical representation of a piece of art and an interactive rating scale that the user may interact with to input a rating for the piece of art. In GUI 100, the user also has the option to navigate to other pages within the application, to skip rating this particular piece of art, or to leave a plain-language comment regarding the piece of art.

The techniques of this disclosure are directed to a software application connected to temporary user-based art exhibits utilizing artificial intelligence to understand the users' taste in art, their likelihood buy art, and showcasing financial data related to the art.

The disclosure describes a system that shows fine art to users. The more the users rate art on the system, the better the artificial intelligence (AI) system can become, and the more likely the user will see more art based on their taste. For instance, a user may be presented with a first piece of art. The first piece of art may have a variety of characteristics, including style, artist, subject, dominant colors, time period, (any other characteristics you can think of). When the user rates the first piece of art, the server inputs the rating into a database for the particular user that includes the particular rating and each of the characteristics for the first piece of art. As the server presents the user with more pieces of art with various characteristics, receives ratings for the respective pieces of art, and stores the ratings in the database, the AI model may determine trends in the data to learn which characteristics may consistently draw high ratings, which characteristics may consistently draw low ratings, and which characteristics may be inconsistent. For instance, if the server determines that the user consistently ranks modern art pieces high, consistently ranks pieces of art with lots of jewel tones low, and inconsistently ranks portraits, the AI model may determine that the user enjoys modern art pieces regardless of other characteristics, dislikes jewel tone colored pieces regardless of other characteristics, and is ambivalent as to whether the piece of art is a portrait. When determining which art viewings to invite the particular user to, the server may determine that modern art shows would be highly of interest to the user, regardless of what the subject of those modern art pieces happens to be.

The system may be implemented either on a mobile device or a computer. In other instances, the server may be implemented on a server device that utilizes a mobile device or a computer as a user input controller while storing and analyzing the data remotely though an application programming interface (API). The system includes an artificial intelligence art advisor, which learns about a variety of art galleries, auction houses, art museums, private sales, and artists through an internal database and a set of algorithms that predicts each user's preferences.

The server may also receive data on financial sales by artists and other collectors. Using the data received from various users and their ratings of various art pieces, the characteristics of the art held by the curator, and the financial data regarding sales of pieces that have similar characteristics as the art held by the curator, the server may predict the average return of fine art and the expected return for the pieces held by the curator if a particular user were to be invited to view the particular piece of art.

The system can use a variety of methods through to predict a user's fine art preferences through either manual human insights or implementing machine learning. The system can output graphical representations of art or ask questions designed to elicit responses and data. The data is compiled by a central device that can be analyzed to learn trends for the user, enabling machine learning for the particular user's preferences.

The system also allows users to submit their owned work to be appraised. The entire system can be supplemented by human art advisors who interact with users on either the mobile device, computer, or in-person experiences. The system may work with art professionals to provide data on the users. This data can be in the form of white papers, e-mails, or direct customer referrals.

The system may compile this data to showcase fine art in either a physical location or a virtual. The fine art is changed out based on the visitors in the space. The visitors may be allowed in the space based on invitations sent out through mobile notifications, e-mail messages, text messages, phone calls, video messages or direct mail.

The fine art is either available to be viewed in either private viewing rooms or studio spaces (either physical or virtual). The private viewing rooms may have a first occupancy limit, with the first occupancy limit being equal to 5 people, 10 people, 20 people, or any other amount of people that the curator deems adequate for a private viewing of the personally curated art pieces. The studio spaces may have a second occupancy limit which is greater than or equal to the first occupancy limit, as the studio spaces may be designed for a more public display of the art pieces. In some examples, the second occupancy limit may be equal to upwards of 50, 100, or 250 people, while other examples may have a smaller or larger occupancy limit based on characteristics of the exhibit that may affect the user experience while viewing and shopping the studio space. The private viewing rooms and the studio spaces change out the fine art available to be viewed at least every 24 hours.

Due to potential occupancy limits, there may be an interest threshold to be considered when determining who gets an invitation to view the art in that space. For instance, the system may select the top X amount of people, the first X amount of people that have an interest level over a certain amount, those with a certain level of probability of purchasing a piece of art shown in the space, or any other potential means of limiting those who will receive an invitation to view the art such that only those with the highest interest levels in viewing or purchasing the art are invited. Visitors are able to buy any of the art shown in the studio spaces or private viewing rooms.

The private viewing rooms and studio spaces may be attached to a secured storage room. The secured storage room may provide the following: a space to hold fine art, a space to prepare shipping material, a secured exit towards the street, and/or a secured entry to the private viewing rooms and studio spaces.

For years, art professionals have said their number one issue is finding new art collectors. However, the traditional method of finding advice for new collectors is through art advisors who tend to only work with rich clientele. The techniques described herein provide a low-cost method to help the average consumer to find art advising advice that is equal or better than a traditional art advisor.

Attending art galleries without any advisor or seeking information on the web is a common method for the average consumer to seek out advice on fine art. There are many drawbacks to this method, because they only give piecemeal amount of information and they may have conflicting interests that do not serve the needs of a consumer.

The techniques described herein solve problems for both the average consumer and art professionals by encouraging fine art collecting. The system allows greater access to fine art by giving personalized guidance through artificial intelligence. The system allows art professionals to have more educated consumers who are more willing to purchase fine art.

In addition, traditional art galleries have based their selection based on the owner's personal taste rather than the selection of the typical consumer. The techniques described herein benefit the typical consumer. Consumers are invited to the location based on invitations. The invitation is based on consumer insights, market research, and the invitee's stated preferences.

Traditional art galleries are a common alternative to user data based temporary art exhibits. Traditional art galleries tend to have poor customer service, they often hide their best fine art pieces for their preferred customers. Traditional art galleries tend to hide their prices, this practice encourages bartering and discrimination. Traditional art galleries do not tend to use market research and data to provide the best selection for users.

The techniques described herein solve the problem of traditional art galleries. The user data based temporary art exhibits design allows consumers to visit an exhibit based on their own personal interest and tastes. The design and the method of the user data based temporary art exhibits allows consumers to buy art with more ease, without suffering the drawbacks associated with traditional art galleries.

The techniques described herein may be used on a mobile device, laptop, or desktop computer, any of which may be connected to a mobile application, a downloadable computer software, or a website through an API or a server connection. The system primarily allows the user to view fine art with a rating system. The user can also rate a piece of fine art in a one to five-star rating system.

The more the user rates, the more preferences are shown to the user. The system may also ask direct questions relevant to the goal of encouraging the user to purchase fine art. The system may also interact with the user through notifications, video, video messages, text messages, phone calls, or emails. The system may also give relevant news to the user based on the user's preferences.

The system may store the user's preferences in a profile. The profile may be publicly accessible. The profile may also be used to store photos of the user's previous fine art purchases and other relevant data.

When a new piece of art is received, the system may perform image analysis on the piece of art to derive styles, color schemes, subjects, medium, and other visual details about the piece of art. Additionally or alternatively, a dealer or gallery staff-person may add details about the piece of art, including artist, title, and any other of the information described herein that can be used to describe a piece of art. Using the various profiles in the system, the AI model may select particular guests to view the new piece of art, those selected guests being the ones that, based on their profiles, are the guests most likely to be interested in viewing and/or purchasing that piece of art. By the nature of the product, pieces of art are unique creations with very limited availability and that may only be for sale on rare occasion. By connecting potential customers with listings for pieces of art as they become available, the customers may discover physical articles of manufacture and creation that they otherwise would not have been aware of.

The invited guest is able to either view a private viewing room or studio space, either physically or virtually. The invited guest can view the art for a particular duration (e.g., eight hours). The invited guest can request to buy the fine art, by either purchasing the art immediately on their mobile device or requesting to purchase from a drop-shipping gallery staff person. After the transaction is complete, the invited guest can either pick up the art immediately or the fine art can be shipped to the guest's preferred location.

The techniques described herein may use a variety of programming languages, databases, and machine learning systems to work. These systems and languages include: Python, CSS, HTML, Javascript, ReactNative, AirTable, and Firebase. The techniques described herein may ultimately compile data to create a temporary art exhibit based on user preferences.

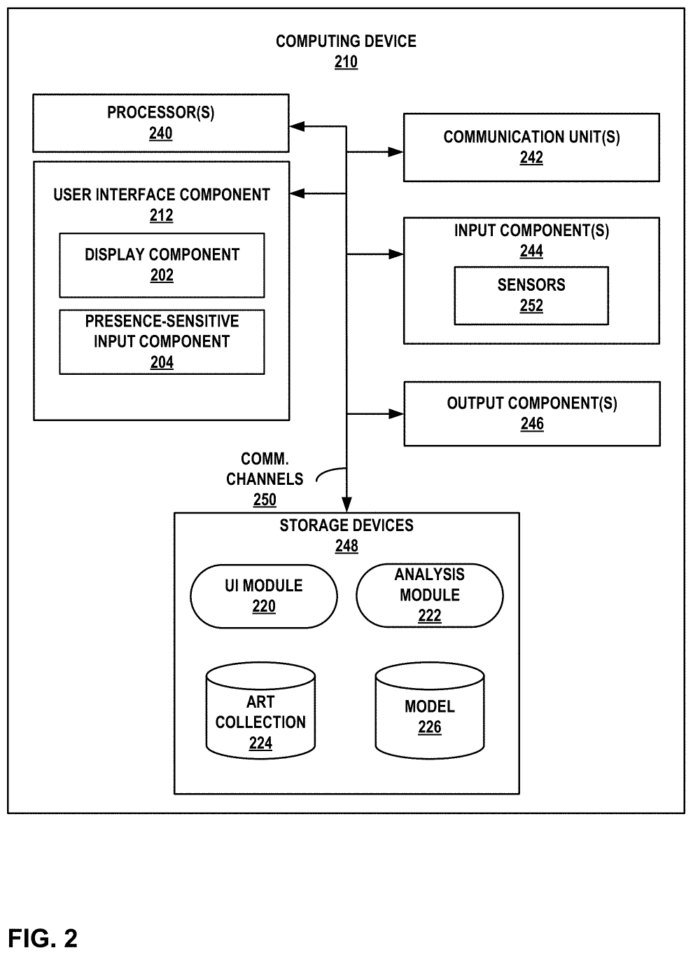

FIG. 2 is a block diagram illustrating a more detailed example of a computing device configured to perform the techniques described herein. Computing device 210 of FIG. 2 is described below as an example of computing device 110 of FIG. 1. FIG. 2 illustrates only one particular example of computing device 210, and many other examples of computing device 210 may be used in other instances and may include a subset of the components included in example computing device 210 or may include additional components not shown in FIG. 2.

As shown in the example of FIG. 2, computing device 210 includes user interface device (UID) 212, one or more processors 240, one or more communication units 242, one or more input components 244, one or more output components 246, and one or more storage components 248. UID 212 includes display component 202 and presence-sensitive input component 204. Storage components 248 of computing device 210 include UI module 220, analysis module 222, art collection database 224, and model 226.

One or more processors 240 may implement functionality and/or execute instructions associated with computing device 210 to determine known user ratings for art and predict ratings of other unrated pieces of art. That is, processors 240 may implement functionality and/or execute instructions associated with computing device 210 to receive user ratings for pieces of art from art collection database 224 and train model 226 using those ratings to predict an interest level in other pieces of art with similar or different characteristics as the rated art.

Examples of processors 240 include application processors, display controllers, auxiliary processors, one or more sensor hubs, and any other hardware configure to function as a processor, a processing unit, or a processing device. Modules 218, 220, 222, and 224 may be operable by processors 240 to perform various actions, operations, or functions of computing device 210. For example, processors 240 of computing device 210 may retrieve and execute instructions stored by storage components 248 that cause processors 240 to perform the operations described with respect to modules 220 and 222, database 224, and model 226. The instructions, when executed by processors 240, may cause computing device 210 to receive user ratings for pieces of art from art collection database 224 and train model 226 using those ratings to predict an interest level in other pieces of art with similar or different characteristics as the rated art.

UI module 220 may perform operations for managing a user interface (e.g., user interfaces 100, 300, and 400) that computing device 210 provides at UID 212. For example, UI module 220 of computing device 210 may present graphical representations of art pieces to a user and receive user input for rating those presented pieces of art.

In some examples, UI module 220 and analysis module 222 may execute locally (e.g., at processors 240) to provide functions associated with analyzing user ratings for art and predicting interest levels in other pieces of art based on those ratings. In some examples, UI module 220 and analysis module 222 may act as an interface to a remote service accessible to computing device 210. For example, UI module 220 and analysis module 222 may be an interface or application programming interface (API) to a remote server that analyzes user ratings and outputs predictions for other pieces of art. In other examples where computing device 210 is the remote server, UI module 220 and analysis module 222 may interact with user devices to send the art to be rated, receive ratings, and monitor preferences for the user.

One or more storage components 248 within computing device 210 may store information for processing during operation of computing device 210 (e.g., computing device 210 may store data accessed by modules 220 and 222, database 224, and model 226 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220 and 222, database 224, and model 226. Storage components 248 may include a memory configured to store data or other information associated with modules 220 and 222, database 224, and model 226.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on one or more networks. Examples of communication units 242 include a network interface card (e.g. such as an Ethernet card), an optical transceiver, a radio frequency transceiver, a GPS receiver, or any other type of device that can send and/or receive information. Other examples of communication units 242 may include short wave radios, cellular data radios, wireless network radios, as well as universal serial bus (USB) controllers.

One or more input components 244 of computing device 210 may receive input. Examples of input are tactile, audio, and video input. Input components 244 of computing device 210, in one example, includes a presence-sensitive input device (e.g., a touch sensitive screen, a PSD), mouse, keyboard, voice responsive system, camera, microphone or any other type of device for detecting input from a human or machine. In some examples, input components 244 may include one or more sensor components 252 one or more location sensors (GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a heart rate sensor, magnetometer, glucose sensor, olfactory sensor, compass sensor, or a step counter sensor.

One or more output components 246 of computing device 210 may generate output in a selected modality. Examples of modalities may include a tactile notification, audible notification, visual notification, machine generated voice notification, or other modalities. Output components 246 of computing device 210, in one example, includes a presence-sensitive display, a sound card, a video graphics adapter card, a speaker, a cathode ray tube (CRT) monitor, a liquid crystal display (LCD), a light emitting diode (LED) display, an organic LED (OLED) display, a virtual/augmented/extended reality (VR/AR/XR) system, a three-dimensional display, or any other type of device for generating output to a human or machine in a selected modality.

UID 212 of computing device 210 includes display component 202 and presence-sensitive input component 204. Display component 202 may be a screen, such as any of the displays or systems described with respect to output components 246, at which information (e.g., a visual indication) is displayed by UID 212 while presence-sensitive input component 204 may detect an object at and/or near display component 202.

While illustrated as an internal component of computing device 210, UID 212 may also represent an external component that shares a data path with computing device 210 for transmitting and/or receiving input and output. For instance, in one example, UID 212 represents a built-in component of computing device 210 located within and physically connected to the external packaging of computing device 210 (e.g., a screen on a mobile phone). In another example, UID 212 represents an external component of computing device 210 located outside and physically separated from the packaging or housing of computing device 210 (e.g., a monitor, a projector, etc. that shares a wired and/or wireless data path with computing device 210).

UID 212 of computing device 210 may detect two-dimensional and/or three-dimensional gestures as input from a user of computing device 210. For instance, a sensor of UID 212 may detect a user's movement (e.g., moving a hand, an arm, a pen, a stylus, a tactile object, etc.) within a threshold distance of the sensor of UID 212. UID 212 may determine a two or three-dimensional vector representation of the movement and correlate the vector representation to a gesture input (e.g., a hand-wave, a pinch, a clap, a pen stroke, etc.) that has multiple dimensions. In other words, UID 212 can detect a multi-dimension gesture without requiring the user to gesture at or near a screen or surface at which UID 212 outputs information for display. Instead, UID 212 can detect a multi-dimensional gesture performed at or near a sensor which may or may not be located near the screen or surface at which UID 212 outputs information for display.

In accordance with one or more techniques of this disclosure, UI module 220 outputs, for display on display component 202, a graphical representation of a first piece of art. The first piece of art is included in a first plurality of pieces of art (e.g., in art collection database 224), where each piece of art in art collection database 224 has known characteristics.

UI module 220 receives an indication of user input indicating a user rating for one or more characteristics of the first piece of art by a particular user account. These characteristics can be any characteristic that is descriptive of the piece of art in any way. For instance, the one or more characteristics can include one or more of an overall composition (e.g., how the user generally feels about the piece of art), a dominant color type (e.g., flesh tones, jewel tones, earth tones, or other colors found in the foreground or subject of the art), a secondary color type (e.g., flesh tones, jewel tones, earth tones, or other colors found in the background of the art), a movement level of the subjects in the art, a texture (either literal texture of the work or the created texture of the subject of the piece of art), a form, a space, a shape, a value, a line type, a unity, a harmony, a variety, a balance, a contrast, a proportion, a pattern, an artist, a time period, a medium, a subject, a region of origination, and a style.

Analysis module 222 develops model 226 based on the user rating for each of the one or more characteristics of the first piece of art. If this is the very first piece of art rated by the particular user, analysis module 222 may develop model 226 by creating model 226 as a new model for the particular user. If this is not the first piece of art rated by the particular user, analysis module 222 may develop model 226 by updating the ratings history in model 226.

Analysis module 222 may further develop model 226 using additional piece of art. For instance, UI module 222 may output, for display on display component 202, a graphical representation of a third piece of art. UI module 222 may receive an indication of second user input indicating a second user rating for one or more characteristics of the third piece of art by the particular user account, and analysis module 222 may update model 226 based on the second user rating for each of the one or more characteristics of the third piece of art.

Analysis module 222 predicts, using model 226, an interest level for the particular user in a second piece of art. The second piece of art is included in a second plurality of pieces of art (e.g., a separate portion of art collection database 224), where each piece of art in the second plurality of pieces of art corresponds to a physical piece of art owned by a dealer.

The interest level may be any variable that indicates a potential interest the particular user may have in another piece of art that has not yet been rated by the user. For instance, the interest level may a binary value indicating interested or not interested. In other instances, the interest level may be one or more of a probability that the particular user would be interested in viewing the second piece of art and a predicted rating from the particular user for the second piece of art. In still other instances, the interest level may be one or more of a probability that the particular user would be interested in purchasing the second piece of art or an expected value received from the particular user when viewing the second piece of art. In such instances, analysis module 222 may update model 226 to include one or more of an amount of money the particular user has available to spend, a number of pieces owned by the particular user, a value of pieces owned by the particular user, a likelihood of the user to attempt to return art they had previously purchased, or a number of pieces the particular user has purchased in response to previous invitations to view pieces of art.

Additionally, analysis module 222 may compile financial sales by an artist who created the second piece of art and financial sales of other pieces of art that share characteristics with the second piece of art and determine a value for the second piece of art. Analysis module 222 may then determine the expected value received from the particular user when viewing the second piece of art based at least in part on model 226, the financial sales by the artist, the financial sales of the other pieces of art that share characteristics with the second piece of art, and the value for the second piece of art.

In predicting the interest level in the second piece of art, analysis module 226 may determine one or more characteristics of the second piece of art. Analysis module 226 may then access model 226 to determine past ratings of the one or more characteristics of the second piece of art in previously rated pieces of art (e.g., art with similar color schemes, subjects, time and country of origin, artist, etc.) and predict the interest level based on the past ratings.

Responsive to the interest level for the particular user in the second piece of art satisfying an interest threshold, UI module 220 sends an invitation to the particular user to view the second piece of art. The threshold may be any variable that may limit the final number of users who may ultimately be invited to view the art. For instance, the threshold may be a binary value associated with interested, a threshold probability the user is interested in viewing the art, a threshold probability the user is interested in purchasing the art, an expected value obtained by inviting the user to view the art, or any other gauge of interest. The interest threshold may also depend on the total number of people who are allowed to be in a physical or virtual space to view the art.

The invitation to view the second piece of art may be an invitation to view the second piece of art in one or more of a physical private viewing, a physical studio space viewing, a virtual private viewing, or a virtual studio space viewing. In sending the invitation to the particular user, UI module 220 may send one or more of a mobile push notification, an e-mail message, a text message, an automated phone call, a video message, or a direct mail message to the particular user.

In some instances, computing device 210 may also act as an appraisal tool for the particular user. For instance, UI module 220 may receive an indication of one or more pieces of art asserted to be owned by the particular user. UI module 220 may also receive a proof of ownership for each of the one or more pieces of art. UI module 220 may then receive an appraisal request for one or more of the one or more pieces of art. Either using model 226 or input from a professional appraiser, UI module 220 may determine an appraisal amount for the one or more of the one or more pieces of art and send the appraisal amount to the particular user in response to the appraisal request.

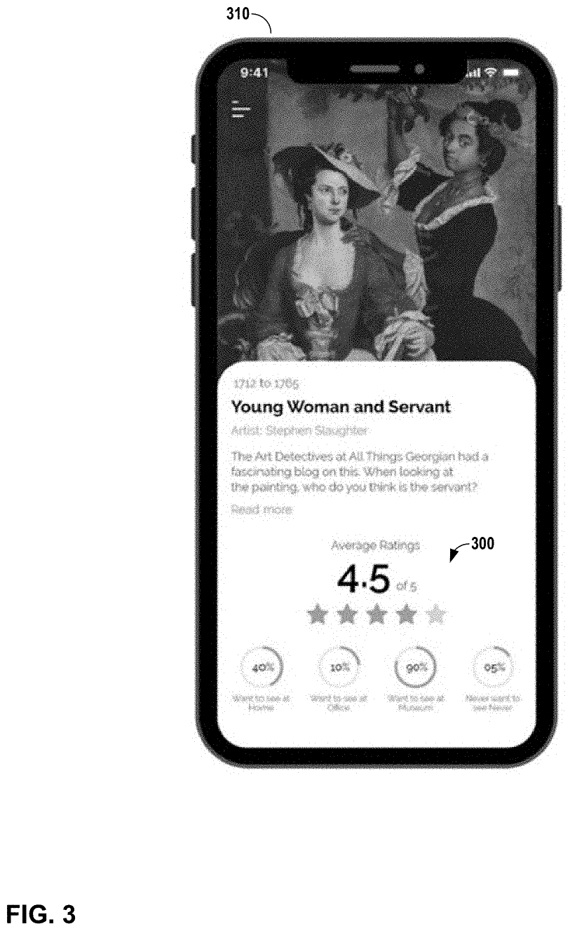

FIG. 3 is a conceptual diagram illustrating an example graphical user interface (GUI) 300, issued by a computing device (e.g., computing device 210), showing a user's rating preference for a particular piece of art, in accordance with one or more of the techniques described herein. Computing device 210 may be a server which communicates with user device 310 to output GUI 300.

GUI 300, as shown in FIG. 3, shows additional information about the piece of art rated in FIG. 1. GUI 300 gives a short background of the painting, some additional predictions as to a setting where the user may appreciate seeing the rated piece of art, as well as an average rating for the user (while other examples may depict an average rating for the painting across all users of the platform). GUI 300 also shows a time period in which the painting was created, a title of the painting, and the artist who created the painting.

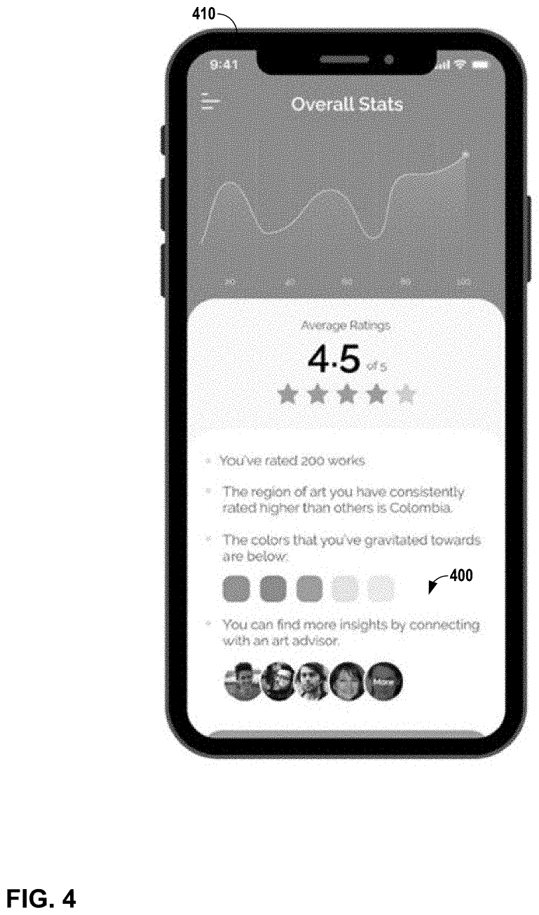

FIG. 4 is a conceptual diagram illustrating an example graphical user interface (GUI) 400, issued by a computing device (e.g., computing device 210), showing a user's rating preference for art in general, in accordance with one or more of the techniques described herein. Computing device 210 may be a server which communicates with user device 410 to output GUI 400.

As shown in GUI 400, the model may take any number of factors into account when determining interest in art and gather ratings and preferences for any number of characteristics of art. In GUI 400, the user has shown, through past ratings of art analyzed by computing device 210, distinct preferences in art that has originated in Colombia and art that includes flesh tones (e.g., browns, tans, yellows, etc.). As such, GUI 400 indicates that the model would predict that this particular user would be extremely interested in a piece of art that includes a number of flesh tones and originates in Colombia, potentially to an extent that a threshold would be satisfied to invite the user to view a piece of art that satisfies those characteristics.

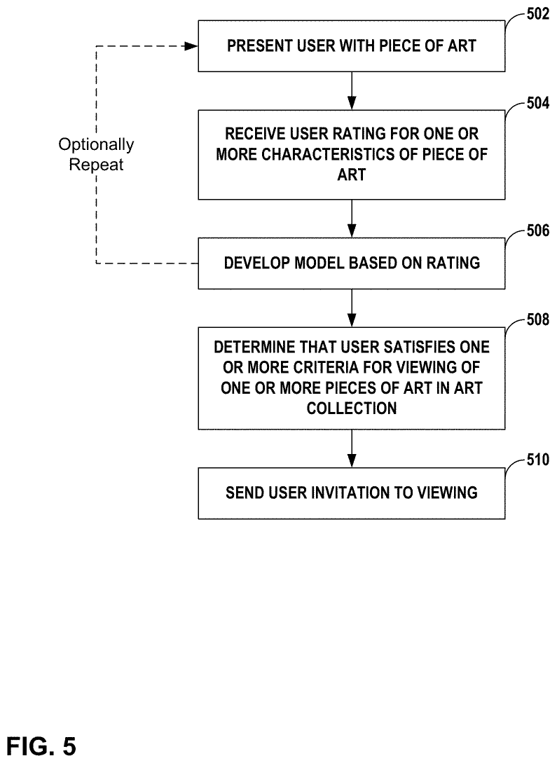

FIG. 5 is a flow diagram illustrating an example interest prediction technique, in accordance with one or more of the techniques described herein. The techniques of FIG. 5 may be performed by one or more processors of a computing device, such as computing device 210 illustrated in FIG. 2. For purposes of illustration only, the techniques of FIG. 5 are described within the context of computing device 210 of FIG. 2, although computing devices having configurations different than that of computing device 210 may perform the techniques of FIG. 5.

In accordance with one or more techniques of this disclosure, UI module 220 outputs, for display on display component 202, a graphical representation of a first piece of art (502). UI module 220 receives an indication of user input indicating a user rating for one or more characteristics of the first piece of art by a particular user account (504). Analysis module 222 develops model 226 based on the user rating for each of the one or more characteristics of the first piece of art (506). Depending on the particular user's intention, UI module 220 may output additional pieces of art and receive additional ratings which analysis module 222 uses to further develop model 226, optionally repeating steps 502-506 so long as the user wishes to refine their tastes. Analysis module 222 predicts, using model 226, an interest level for the particular user in a second piece of art (508). Responsive to the interest level for the particular user in the second piece of art satisfying an interest threshold, UI module 220 sends an invitation to the particular user to view the second piece of art (510).

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples of the disclosure have been described. Any combination of the described systems, operations, or functions is contemplated. These and other examples are within the scope of the following claims.

What is claimed is:

1. A method comprising:
outputting, by a computing device and for display on a display component, a graphical representation of a first piece of art;
receiving, by the computing device, an indication of user input indicating a user rating for one or more characteristics of the first piece of art by a particular user account;
developing, by the computing device, a model based on the user rating for each of the one or more characteristics of the first piece of art;
predicting, by the computing device, and using the model, an interest level for the particular user in a second piece of art; and
responsive to the interest level for the particular user in the second piece of art satisfying an interest threshold, sending, by the computing device, an invitation to the particular user to view the second piece of art.

2. The method of claim 1, further comprising:
outputting, by the computing device and for display on the display component, a graphical representation of a third piece of art;
receiving, by the computing device, an indication of second user input indicating a second user rating for one or more characteristics of the third piece of art by the particular user account;
updating, by the computing device, the model based on the second user rating for each of the one or more characteristics of the third piece of art.

3. The method of claim 1, wherein the first piece of art is included in a first plurality of pieces of art, wherein each piece of art in the first plurality of pieces of art has known characteristics.

4. The method of claim 3, wherein the second piece of art is included in a second plurality of pieces of art, wherein each piece of art in the second plurality of pieces of art corresponds to a physical piece of art owned by a dealer.

5. The method of claim 1, wherein the one or more characteristics comprise one or more of:
an overall composition;
a dominant color type;
a secondary color type;
a movement level;
a texture;
a form;
a space;
a shape;
a value;
a line type;
a unity;
a harmony;
a variety;
a balance;
a contrast;
a proportion;
a pattern;
an artist;
a time period;
a medium;
a subject;
a region of origination; and
a style.

6. The method of claim 1, wherein the interest level comprises a binary value indicating interested or not interested, and wherein the threshold comprises the binary value associated with interested.

7. The method of claim 1, wherein the interest level comprises one or more of a probability that the particular user would be interested in viewing the second piece of art and a predicted rating from the particular user for the second piece of art.

8. The method of claim 1, wherein the interest level comprises one or more of a probability that the particular user would be interested in purchasing the second piece of art or an expected value received from the particular user when viewing the second piece of art,
wherein the method further comprises updating, by the computing device, the model to include one or more of an amount of money the particular user has available to spend, a number of pieces owned by the particular user, a value of pieces owned by the particular user, a likelihood of the particular user to return a purchased piece of art, or a number of pieces the particular user has purchased in response to previous invitations to view pieces of art.

9. The method of claim 8, wherein the interest level comprises the expected value received from the particular user when viewing the second piece of art, wherein the method further comprises:
compiling, by the computing device, financial sales by an artist who created the second piece of art and financial sales of other pieces of art that share characteristics with the second piece of art;
determining, by the computing device, a value for the second piece of art, and
determining, by the computing device, the expected value received from the particular user when viewing the second piece of art based at least in part on the model, the financial sales by the artist, the financial sales of the other pieces of art that share characteristics with the second piece of art, and the value for the second piece of art.

10. The method of claim 1, wherein the invitation to view the second piece of art comprises an invitation to view the second piece of art in one or more of a physical private viewing, a physical studio space viewing, a virtual private viewing, or a virtual studio space viewing.

11. The method of claim 1, wherein sending the invitation to the particular user comprises sending one or more of a mobile push notification, an e-mail message, a text message, an automated phone call, a video message, or a direct mail message to the particular user.

12. The method of claim 1, further comprising:
receiving, by the computing device, an indication of one or more pieces of art asserted to be owned by the particular user;
receiving, by the computing device, a proof of ownership for each of the one or more pieces of art;
receiving, by the computing device, an appraisal request for one or more of the one or more pieces of art; and
sending, by the computing device, an appraisal amount to the particular user in response to the appraisal request.

13. The method of claim 1, wherein predicting the interest level in the second piece of art comprises:
determining, by the computing device, one or more characteristics of the second piece of art;
accessing, by the computing device, the model to determine past ratings of the one or more characteristics of the second piece of art in previously rated pieces of art; and
predicting, by the computing device, the interest level based on the past ratings.

14. A device comprising:
one or more storage components configured to store a model; and
one or more processors configured to:
output, for display on a display component, a graphical representation of a first piece of art;
receive an indication of user input indicating a user rating for one or more characteristics of the first piece of art by a particular user account;
develop the model based on the user rating for each of the one or more characteristics of the first piece of art;
predict and using the model, an interest level for the particular user in a second piece of art; and
responsive to the interest level for the particular user in the second piece of art satisfying an interest threshold, send an invitation to the particular user to view the second piece of art.

15. The device of claim 14, wherein the one or more processors are further configured to:
output, for display on the display component, a graphical representation of a third piece of art;
receive an indication of second user input indicating a second user rating for one or more characteristics of the third piece of art by the particular user account;
update the model based on the second user rating for each of the one or more characteristics of the third piece of art.

16. The device of claim 14, wherein the first piece of art is included in a first plurality of pieces of art, wherein each piece of art in the first plurality of pieces of art has known characteristics.

17. The device of claim 16, wherein the second piece of art is included in a second plurality of pieces of art, wherein each piece of art in the second plurality of pieces of art corresponds to a physical piece of art owned by a dealer.

18. The device of claim 14, wherein the interest level comprises one or more of a probability that the particular user would be interested in purchasing the second piece of art or an expected value received from the particular user when viewing the second piece of art,
wherein the one or more processors are further configured to update the model to include one or more of an amount of money the particular user has available to spend, a number of pieces owned by the particular user, a value of pieces owned by the particular user, or a number of pieces the particular user has purchased in response to previous invitations to view pieces of art.

19. The device of claim 18, wherein the interest level comprises the expected value received from the particular user when viewing the second piece of art, wherein the one or more processors are further configured to:
compile financial sales by an artist who created the second piece of art and financial sales of other pieces of art that share characteristics with the second piece of art;
determine a value for the second piece of art, and
determine the expected value received from the particular user when viewing the second piece of art based at least in part on the model, the financial sales by the artist, the financial sales of the other pieces of art that share characteristics with the second piece of art, and the value for the second piece of art.

20. A non-transitory computer-readable storage medium having stored thereon instructions that, when executed, cause one or more processors of a computing device to:
output, for display on a display component, a graphical representation of a first piece of art;
receive an indication of user input indicating a user rating for one or more characteristics of the first piece of art by a particular user account;
develop a model based on the user rating for each of the one or more characteristics of the first piece of art;
predict and using the model, an interest level for the particular user in a second piece of art; and
responsive to the interest level for the particular user in the second piece of art satisfying an interest threshold, send an invitation to the particular user to view the second piece of art.
